(19) United States
(12) Patent Application Publication
(10) Pub. No.: US 2008/0245190 A1
(43) Pub. Date: Oct. 9, 2008

(54) FOOD GUIDE FOR USE WITH A DISPENSING END OF A CONTAINER

(76) Inventor: Anthony Sarazin, Hancock, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/695,774

(22) Filed: Apr. 3, 2007

(51) Int. Cl. B67B 7/44

(52) U.S. Cl. 81/3.09

(57) ABSTRACT

A tool (10) for use with a container (12) having a dispensing end (14) includes a guide (16). The guide (16) has an generally frustoconical portion (18) and a neck portion (19). The neck portion (19) has a distal end portion (32) and a stopper (34). The distal end portion (32) optionally seats against the dispensing end (14) of the container (12) to guide food from the generally frustoconical portion (18) into a dispensing opening (24) of the dispensing end (14) of the container (12). The tool (10) optionally includes a recess (28) in the generally frustoconical portion (18). Furthermore, the tool (10) may include a cap-removing projection (20). In addition, the tool (10) may have an accessory (60) that is either pivotably or removably attached to the guide (16).

### BACKGROUND OF THE INVENTION

1. Field of the Invention

The invention relates to a tool for use with a container having a dispensing end.

2. Background Art

Users often have difficulty inserting food into a relatively narrow dispensing opening of a container (e.g., a bottle). For example, a user may have difficulty inserting a slice or wedge of citrus fruit into a bottle of beer. This situation typically arises when a user desires to garnish or flavor a beverage with a piece of lemon, lime or other food.

Prior art patents include U.S. Pat. Nos. 6,991,822; 6,568,155; 6,425,424; 6,389,783; 5,927,353; 3,602,396; and U.S. Design Patent No. 288,059.

### SUMMARY OF THE INVENTION

One aspect of the invention is to provide a simple, compact, ergonomic and stable tool that provides for the compression of fruit within a guide to a size that is easily transferred into the container. Furthermore, the guide may be quickly and easily placed or positioned over a dispensing opening of a container. In addition, the guide may be used to efficiently direct fruit juice into the container while minimizing the risk of spilling the juice outside the guide.

Ergonomic and safety features that minimize user strain and force and maximize user comfort while using a guide are also provided. For example, the guide allows a user to push food near a distal end of the dispensing end of the container to ensure the complete exit of food from the guide and to reduce the amount of effort exerted by a user.

Similarly, the guide may allow a user to push food near the distal end of the dispensing end of a container and to increase the crushing force that can be delivered by a finger or fingers of the user to the food. The guide optionally includes a finger cushion that enhances user comfort and safety. Furthermore, the guide may be reinforced and stiffened to provide extra durability and stability. The tool may also provide a convenient way to store or hang the guide.

One aspect of the invention includes a compact, simple, ergonomic and stable tool for inserting food into containers. In one embodiment, the tool has a guide having an generally frustoconical portion for guiding food and a cap-removing projection for removing a cap from a dispensing end of a container. The guide optionally includes a recess in the generally frustoconical portion of the guide. The guide also has a neck portion that may be used to guide food into the container. The neck portion has a distal end portion for seating the neck portion against the dispensing end of the container. In addition, the neck portion has a stopper for preventing a distal end of the dispensing end of the container from extending past the neck portion.

A second aspect of the invention includes an accessory that may be either pivotably or removably attached to the guide. In some embodiments, the accessory optionally includes a cap remover and a blade portion. The cap remover may be used to remove a cap from the container. The blade portion may be used to cut food in preparation for insertion of food into the guide.

Another aspect of the invention provides a sheath portion of the guide. The sheath portion may be used to secure the blade portion of the accessory to the guide.

Other advantages and useful embodiments are disclosed or suggested in the claims, the description of the figures, and the drawings.

### BRIEF DESCRIPTION OF THE DRAWINGS

FIG. 1 is a schematic partial side view of a tool (assumed to be transparent for the purposes of FIG. 1) having an optional cap-removing projection of a guide near a cap of a container;

FIG. 2 is a perspective view illustrating a generally frustoconical portion of the guide having a profile that accommodates an outer contour of a longitudinally-sliced piece of lime;

FIG. 3 is a perspective view illustrating one embodiment of the tool connected to a dispensing end of the container and a thumb of a user positioned within a recess of the guide;

FIG. 4 is a partial sectional view of the tool illustrating the thumb of a user atop a cushion of a flange of the tool;

FIG. 5 is a side sectional view illustrating the flange circumscribing an upper edge of the generally frustoconical portion of the guide;

FIG. 6 is a side view illustrating the neck portion having a beveled collar proximate to the dispensing end of the container;

FIG. 7 is a vertical sectional view illustrating the beveled collar projecting inwardly within the neck portion;

FIGS. 8 and 9 are side sectional views illustrating a distal end portion of the neck portion seated against an outer lower ridge and a stopper contacting a distal end of the dispensing end;

FIG. 10 is a perspective view illustrating the tool having an accessory pivotably attached to the guide;

FIG. 11 is a side view illustrating the accessory having a cap remover and a blade portion;

FIG. 12 is a side view illustrating the blade portion of the accessory stored in a sheath portion of the guide;

FIG. 13 is a top plan view illustrating the sheath portion having an interlocking projection; and

FIG. 14 shows a side sectional view of the sheath portion having the interlocking projection and a front view of the blade portion secured within the sheath portion of the guide.

### DETAILED DESCRIPTION OF THE PREFERRED EMBODIMENT(S)

FIG. 1 depicts a tool 10 for use with a container 12 having a dispensing end 14 in accordance with the invention includes a guide 16. The guide 16 has a generally frustoconical portion 18 and a neck portion 19. The term “frustoconicial” is used to include a shape having conical, elliptical or both conical and elliptical cross sections.

The generally frustoconical portion 18 is used for guiding food into the neck portion 19. Food may include a wedge or piece of lime fruit, but also may include other types of food. Furthermore, the generally frustoconical portion 18 may have a generally frustoconical shape and an attachment hole 21. The attachment hole 21 allows the tool 10 to attach to a key chain, lanyard, hanger projection, or similar device.

The neck portion 19 (FIG. 1) may be seated against the dispensing end 14 of the container 12 to guide food from the generally frustoconical portion 18 of the guide 16 into a dispensing opening 24 (shown in FIG. 4) of the dispensing end 14 of the container 12. In the preferred construction of the tool 10, the guide 16 and the neck portion 19 of the tool 10 form a single part. The tool 10 may be made of plastic, metal or a combination of plastic and metal. Furthermore, the tool 10 may have color similar to the color of fruit such as lime green, lemon yellow, red and orange.

With continuing reference to FIG. 1, the tool 10 may include a cap-removing projection 20. The cap-removing projection 20 extends inwardly from the generally frustoconical portion 18 of the guide 16. The cap-removing projection 20 may be used to remove a cap 22 from the dispensing opening 24 of the dispensing end 14 of the container 12.

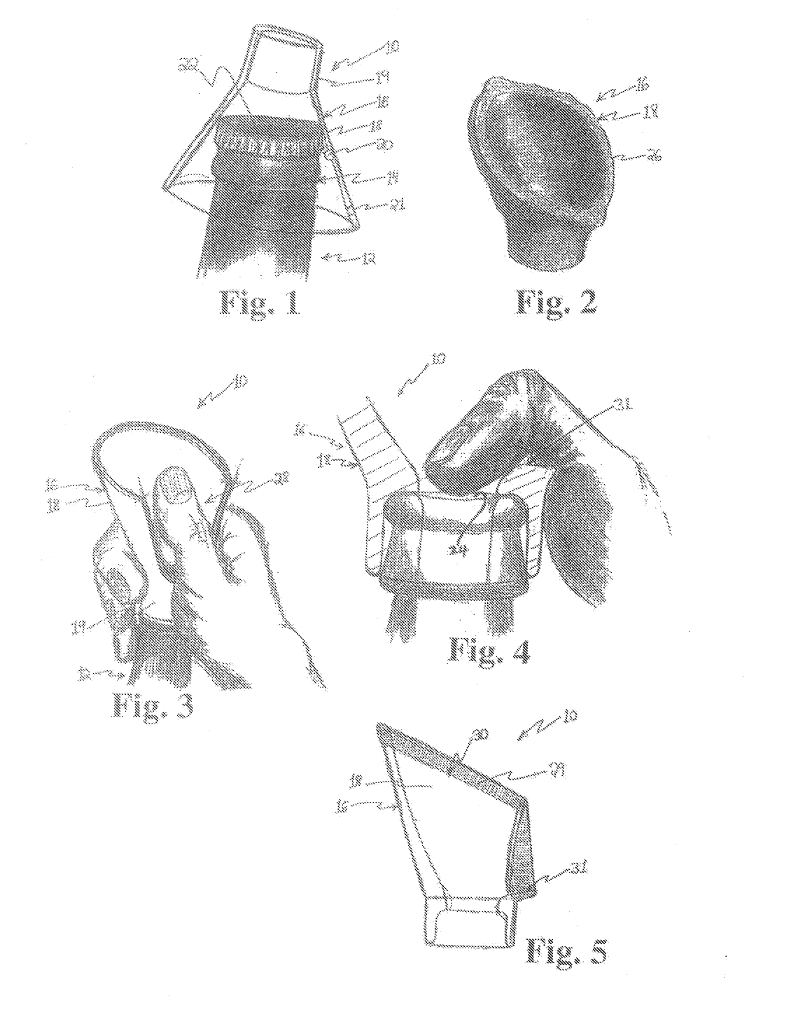

FIG. 2 depicts an embodiment wherein the generally frustoconical portion 18 of the guide 16 has a profile 26 that accommodates an outer contour of a longitudinally-sliced piece of lime.

As shown in FIG. 3, the tool 10 optionally includes a recess 28 in the generally frustoconical portion 18 of the guide 16. The recess 28 extends toward the neck portion 19 to facilitate movement of food through the guide 16 and into the dispensing opening 24 (shown in FIG. 4) of the container 12. For example, the recess 28 may facilitate thumb-pushing movement of a lime wedge into a long-neck bottle.

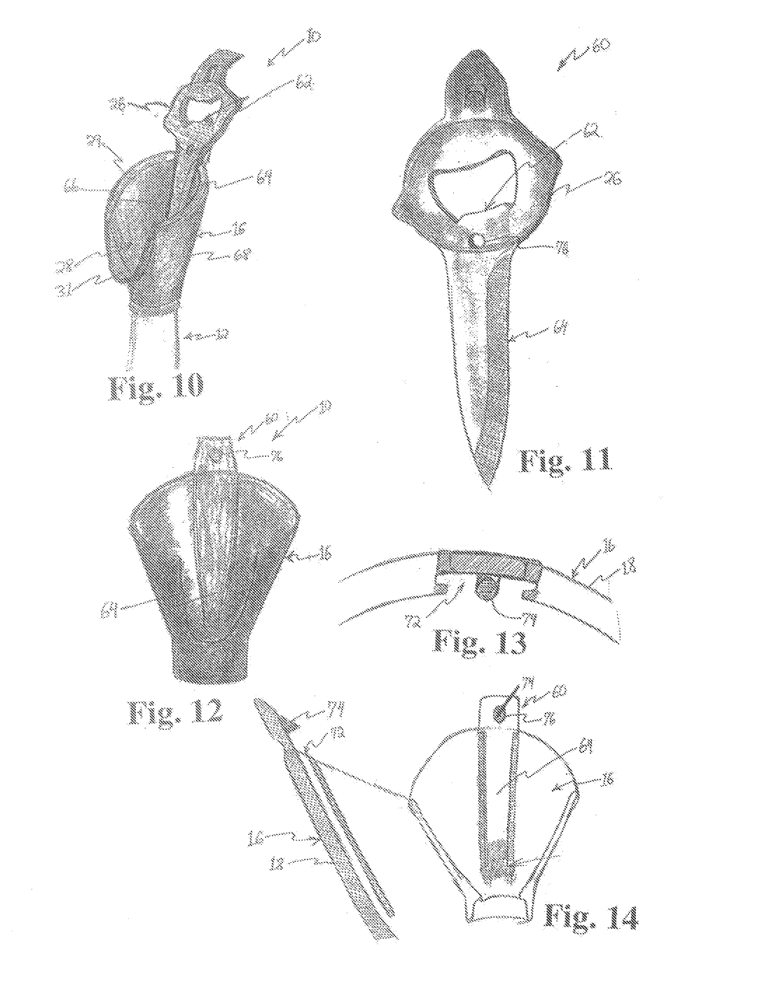

With reference to FIGS. 4 and 5, the generally frustoconical portion 18 of the guide 16 may include a flange 29 (also shown in FIG. 10). The flange 29 circumscribes an upper edge 30 of the generally frustoconical portion 18 of the guide 16 to stiffen and/or reinforce the guide 16 of the tool 10.

Optionally, the flange 29 may provide a cushion 31 proximate to the recess 28 (also shown in FIG. 10) of the guide 16 to provide a landing area for a user's thumb near the recess 28 (also shown in FIG. 10) of the guide 16. The flange 29 may increase in length or thickness as the flange 29 tapers toward the cushion 31. The guide 16, the neck portion 19 and the flange 29 may form a single part.

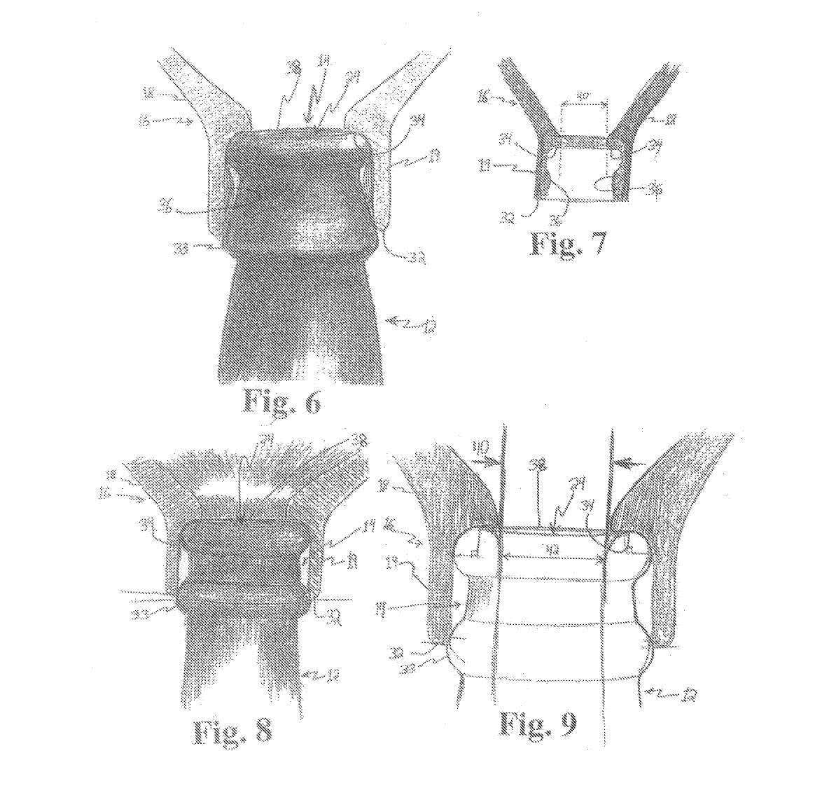

Turning now to FIGS. 6-9, the neck portion 19 has a distal end portion 32. The distal end portion 32 of the neck portion 19 seats on an outer lower ridge 33 of the dispensing end 14 of the container 12. In addition, the distal end portion 32 of the neck portion 19 may be used to seat against to the dispensing end 14 of the container 12.

In some embodiments, the guide 16 includes a stopper 34. The stopper 34 projects inwardly within the neck portion 19 of the guide 16. The stopper 34 prevents a distal end 38 of the dispensing end 14 from extending past the neck portion 19 and into area generally within the generally frustoconical portion 18 of the guide 16.

With reference to FIGS. 6 and 7, the neck portion 19 may include an inner beveled collar 36. The collar 36 projects inwardly within the neck portion 19 between the stopper 34 and the distal end portion 32 of the neck portion 19. The collar 36 secures the guide 16 to the distal end portion 32 between the outer lower ridge 33 and the distal end 38 of the container 12. The collar 36 is flexible and may be made of number of materials such as plastic and silicon-based substances.

As seen in FIGS. 6, 8, and 9, the neck portion 19 circumscribes the dispensing end 14 of the container 12. The distal end portion 32 contacts the outer lower ridge 33 and the stopper 34 contacts the distal end 38 of the dispensing end 14 to provide a secure fit between the guide 16 and the dispensing end 14 of the container 12. Furthermore, the stopper 34 of the guide 16 may have a ninety-degree curved exterior surface to accommodate the distal end 38 of the container 12.

With reference to FIGS. 7 and 9, the stopper 34 optionally has an inner stopper diameter 40 approximating the inner diameter 42 of the dispensing opening 24 of the container 12 to facilitate movement of food and any juice expelled from food into the dispensing opening 24 of the container 12.

Turning now to FIGS. 10, 11, 12, and 14, the tool 10 includes an accessory 60. The accessory 60 may be either pivotably attached to the guide 16 (shown in FIG. 10) or removably attached to the guide 16 (shown in FIG. 12). The accessory may be metallic.

With reference to FIGS. 10 and 11, the accessory 60 optionally includes a cap remover 62. The cap remover 62 is used to remove the cap 22 (shown in FIG. 1) from the container 12.

As shown in FIG. 11, the cap remover 62 may have a profile 26 that accommodates an outer contour of a longitudinally-sliced piece of lime. In addition, the accessory 60 optionally includes a blade portion 64, positioned opposite the cap remover 62 (shown in FIGS. 10 and 11, but not shown in FIG. 12), for cutting food in preparation for insertion of food into the guide 16.

The blade portion 64 (FIG. 10) of the accessory 60 may be pivotably attached to the guide 16 such that the blade portion 64 pivots outwardly away from an inner surface 66 of the guide 16 when the cap remover 62 of the accessory 60 is pivoted downward toward an outer surface 68 of the guide 16. The blade portion 64 pivots inwardly toward the inner surface 66 of the guide 16 when the cap remover 62 is pivoted up away from the outer surface 68 of the guide 16.

With reference to FIGS. 11-14, the blade portion 64 of the accessory 60 may be removably attached to the guide 16 such that the blade portion 64 may be stored in a sheath portion 72 of the guide 16. The sheath portion 72 of the guide 16 may include an interlocking projection 74. The interlocking projection 74 may be used to secure the accessory 60 in the sheath portion 72. The accessory 60 secured in the sheath portion 72 may be used to provide the guide 16 having the cap-removing projection 20 with an extended effective leverage-arm to facilitate removal of the cap 22 (shown in FIG. 1) from the container 12.

As depicted in FIGS. 11, 12 and 14, the accessory 60 may include an interlocking receiver 76. For example, the interlocking receiver 76 may be a hole positioned between the blade portion 64 and the cap remover 62 of the accessory 60. The interlocking receiver 76 is used to receive the interlocking projection 74 and secure the accessory 60 in the sheath portion 72.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A tool for use with a container having a dispensing end, the tool comprising:
a guide having a generally frustoconical portion and a neck portion;
a stopper projecting inwardly within the neck portion; and
a distal end portion of the neck portion for seating against an outer lower ridge of the dispensing end of the container.

2. The tool as in claim 1, wherein the tool includes a cap-removing projection extending inwardly from the generally frustoconical portion for removing a cap from a dispensing opening of the dispensing end of the container.

3. The tool as in claim 1, wherein the tool includes a recess provided in the generally frustoconical portion, wherein the recess extends toward the neck portion.

4. The tool as in claim 1, wherein the tool includes an accessory.

5. The tool as in claim 4, wherein the accessory includes a cap remover for removing a cap from the container.

6. The tool as in claim 4, wherein the accessory includes a blade portion.

7. The tool as in claim 2, wherein the tool includes an accessory.

8. The tool as in claim 7, wherein the accessory includes a cap remover for removing a cap from the container.

9. The tool as in claim 7, wherein the accessory includes a blade portion.

10. The tool as in claim 3, wherein the tool includes an accessory.

11. The tool as in claim 10, wherein the accessory includes a cap remover for removing a cap from the container.

12. The tool as in claim 10, wherein the accessory includes a blade portion.

13. The tool as in claim 4, wherein the tool includes a sheath portion of the guide.

14. The tool as in claim 13, wherein the accessory includes a cap remover for removing a cap from the container.

15. The tool as in claim 13, wherein the accessory includes a blade portion.

16. A tool assembly for use with a container having a dispensing end, the tool assembly comprising:
a generally frustoconical guide with a neck portion, a stopper projecting inwardly therewithin, a distal end portion of the neck portion being adapted for seating against an outer lower ridge of the dispensing end of the container;
a cap-removing projection extending inwardly within the frustoconical guide for removing a cap from the container;
a recess provided within the frustoconical guide so that a user can insert a thumb or finger within the frustoconical guide; and
an accessory including a cap remover, a blade portion, and a sheath that is detachably attached to the frustoconical guide, the sheath accommodating the blade portion.
